(19) United States
(12) Patent Application Publication
(10) Pub. No.: US 2008/0052193 A1
(43) Pub. Date: Feb. 28, 2008

(54) Integrated Communication Systems and Methods for Purpose of Product Presentation and Direct Sales

(76) Inventor: Alexander Katzner, Mettmann (DE)

Correspondence Address: HOFFMAN WARNICK & D'ALESSANDRO, LLC, 75 STATE STREET, 14TH FLOOR, ALBANY, NY, 12207, US

(21) Appl. No.: 11/844,567

(22) Filed: Aug. 24, 2007

Related U.S. Application Data
(60) Provisional application No. 60/823,565, filed on Aug. 25, 2006.

(51) Int. Cl. G06F 17/30; G06Q 30/00

(52) U.S. Cl. 705/27

(57) ABSTRACT

A system to automatically consolidate and standardize different digitized product offers of various companies on the basis of a fully integrated process chain to automatically and on the basis of a fully integrated process chain, collectively communicate and market the product offers to end-users via various media retaining the product offers company identification. The system may provide a digital, illustrated platform and a single user interface and/or a page layout program that are supported by an end-user-presentation-layer, a supplier-application-layer and a processing-application-layer interfacing the end-user-presentation- and supplier-application-layer.

### PRIORITY DATA

This application claims priority to co-pending provisional application Ser. No. 60/823,565 filed on Aug. 25, 2006 entitled “Integrated Communication Systems and Methods for Purpose of Product Presentation and Direct Sales,” the contents of which is hereby incorporated by reference.

### FIELD OF THE INVENTION

The present invention relates generally to the field of electronic business (“e-business”), and, more particularly to the field of business-to-consumer (“B2C”) database publishing (“DBP”), electronic commerce and transactions (“e-commerce”) and/or catalog business.

### BACKGROUND

Retail chains are increasingly replacing brands with private labels, which, in turn, become competitive brands over time. This is due to the fact that these large retailers have learned that they may earn higher margins while simultaneously reducing the number of brands they need to support. The consequence of this is that brand manufacturers are searching for alternative distribution channels to those they currently have. Because direct sales is an overall growing market segment, it first seems like an attractive alternative; however, the high cost of building up a marketing, sales and supply chain infrastructure often results in unacceptable financial risk. Moreover, mid-size brand manufacturers have a reasonable concern of being dropped by their own distributors, if they go into direct competition with them.

The ideal solution to these challenges is a system which allows brands to gain authority over retail pricing, assortments, volume of sales, and the image/positioning of the brand, itself, without being seen as a direct competitor to their traditional distribution chain. This solution would also have to minimize the financial exposure brands face while building up this new channel to market. This can be achieved through a combined mall and trade representative concept. Technologically, this means that the various brand's product catalogs are aggregated in a single, standardized online mall concept with fully automated process chains back to the brand company's own ERP and logistics systems, while preserving the brand identity in the presentation to the end-user. To date, no such “matrix” eCommerce solution exists. The result is that brand companies find it inefficient to generate new sales opportunities or break away from the dependency they have on retailers, who hold practical authority over pricing, assortments, volume of sales and image/positioning of the brand (insofar as the point-of-sale presence is concerned). Further, as brands cannot control the assortment retailers will sell or promote, they are unable to present an entire “collection” to the market in a consolidated fashion, and no platform exists to give brands the ability to work synergistically, through a common platform, with other brand companies to cooperatively cross-promote products and services.

### SUMMARY OF THE INVENTION

The present invention relates to integrated (online/offline) communication systems and methods for the purpose of product presentation and direct sales of various companies to end-consumers in competitive markets for goods under one umbrella. The invention provides a system by which a various number of companies can provide goods to end-consumers through a common media platform, while retaining their individual appearance as if the end-consumer were acting with different companies, but nevertheless permitting one-stop transactions as if the end-consumer were acting with a single company.

It provides a method for a various number of companies to take advantage of the stronger position on the market resulting from a common approach, while benefiting from the flexibility and nimbleness of an individual company and of a unified group operating from one source.

Similarly, it allows the various companies to capitalize from the conglomeration of numerous brand market values and on its previously non existing opportunities to cross-sell to end-consumers and by consequence to economize new end-consumer acquisition.

A system and method is disclosed for providing electronic business operations via a digital mall, wherein the digital mall integrates a plurality of supplier brands, each one operating a different product catalog data storage facility, the process gives a digital mall the possibility to present/sell a whole range supplier brand products through common presentation/interaction layers to the end-user without the necessity of digitizing or importing a whole range of up-to-date product data of each of the plurality of the supplier brands manually. The method allows the supplier brands to gain authority over product pricing, assortments, volume of sales and image/positioning of the brand.

Accordingly, the various companies participated in the digital mall stand to profit due to the end user's ability to communicate at each at one web address.

In a first aspect, the invention provides a system for providing automated processing of sales relevant product data for a plurality of companies via a network, comprising: a supplier application layer that provides an interface with an ERP system associated with each of the plurality of companies, wherein the supplier application layer provides a conduit through which product content of each company can be accessed; a processing application layer that includes a content management system for storing and managing product content for each of the plurality of companies, wherein the content management system allows each company to selectively load product content from their respective ERP system; and an end user presentation layer that includes an interface for displaying product content from each of the plurality of companies, and for allowing end users to purchase products from each of the plurality of companies in which transaction data is routed directly back to the ERP system of a selling company via the supplier application layer.

In a second aspect, the invention provides a program product stored on a computer readable medium for providing digital mall over a computer network, comprising: program code configured for providing a company interface with an ERP system associated with each of a plurality of companies, wherein the company interface provides a conduit through which product content of each company can be accessed; program code for storing and managing product content for each of the plurality of companies, wherein program code for storing and managing product content allows each company to selectively load product content from their respective ERP system; and program code for providing a user interface for displaying product content from each of the plurality of companies, and for allowing end users to purchase products from each of the plurality of companies wherein transaction data is routed directly back to the ERP system of a selling company via the company interface.

In a third aspect, the invention provides a method for providing a digital mall environment over a computer network, comprising: providing a direct conduit through which product content of each of a plurality of companies can be accessed; storing and managing product content for each of the plurality of companies in a centralized repository; providing an interface for allowing each company to manage product content within the centralized repository; providing a user interface via the computer network for displaying product content from each of the plurality of companies; obtaining an order from an end user over the user interface; and routing transaction data associated with the order directly back to a selling company via the direct conduit.

These and other aspects of the invention, along with various features and advantages, are disclosed in the appended documentation and are covered, in whole or in part, by the appended claims.

### BRIEF DESCRIPTION OF THE DRAWINGS

FIG. 1 shows an embodiment of a website associated with a single user interface associated with the common digital mall platform.

FIG. 2 shows an illustrative media platform in an embodiment of the present invention providing common end-user access to a homepage and the various brand-stores of a digital mall.

FIG. 3 shows an embodiment of a system according to the present invention for processing of sales relevant product data from a supplier's product catalog into a data storage facility which provides various media output channels.

FIG. 4 shows a system overview of an embodiment of the present invention.

### DESCRIPTION OF THE INVENTION

The invention provides an online digital mall interface for “brands” seeking to have a web presence on the internet without building an ecommerce infrastructure. Conceptually, the idea is similar to what is provided by AMAZON or even EBAY. However, the invention is distinguished from those systems in that a system is provided that directly links to the ERP infrastructure of the brand manufacturer. This allows participating companies to seamlessly manage product content at the digital mall and obtain/process transaction data from end users visiting the digital mall.

ERP (enterprise resource planning) is an industry term for the broad set of activities supported by multi-module application software that helps a manufacturer or other business manage the important parts of its business, including product planning, parts purchasing, maintaining inventories, interacting with suppliers, providing end-user service, and tracking orders. ERP can also include application modules for the finance and human resources aspects of a business. Typically, an ERP system uses or is integrated with a relational database system. The deployment of an ERP system can involve considerable business process analysis, employee retraining, and new work procedures.

Thus, in the current approach, the brand manufacturer does not need to upload/convert data to the data model of the digital mall. Instead, a system is provided that provides a conduit right into the brand manufacturer's ERP system (e.g., using a custom interface) to allow the brand manufacturer to have complete control over things like pricing, selection, etc. Moreover, as transactions occur at the digital mall, transactional information can be reported right back to the ERP system of the brand manufacturer in real time (as opposed to a batch mode).

Similarly, the brand manufacturer can control what appears in the digital mall from their own ERP systems, without having to interface with the digital mall's systems. Thus, the invention provides a seamless transactional space through which a brand manufacturer can market their products without having to conform to the data model and rules of an intermediary system, such as AMAZON.

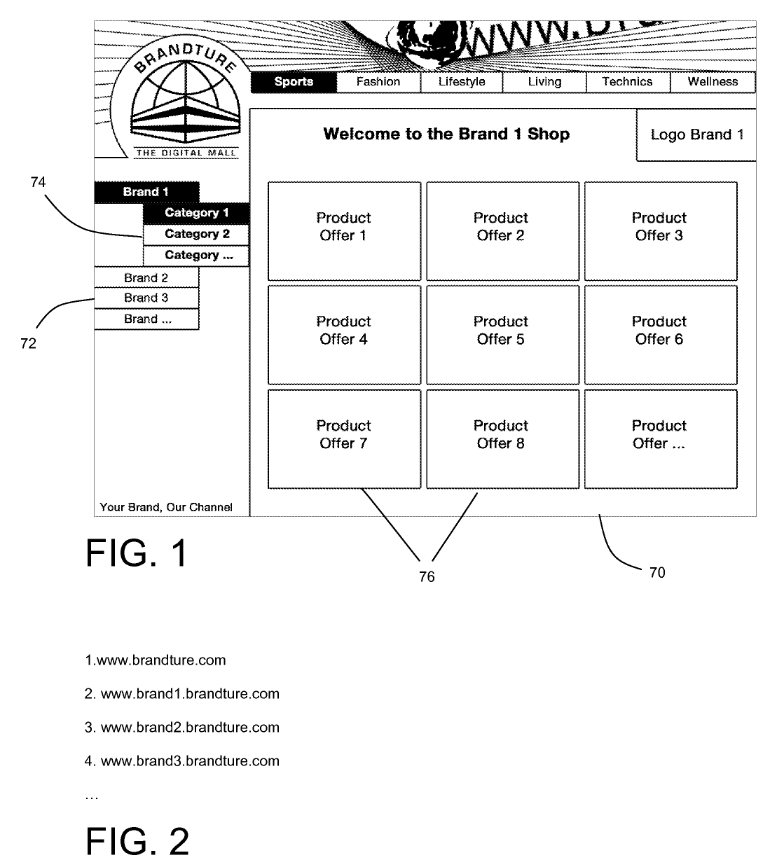

FIG. 1 depicts an illustrative website 70 through which a single user interface is provided to access a common digital mall platform. The website 70 allows the user to select a brand 72 (e.g., NIKE®, TITLIST®, etc.), and then drill down to a category 74 (e.g., equipment, clothing, etc.), and then view different product offerings 76. FIG. 2 shows an illustrative media platform providing common end-user access to a homepage and the various brand-stores of a digital mall.

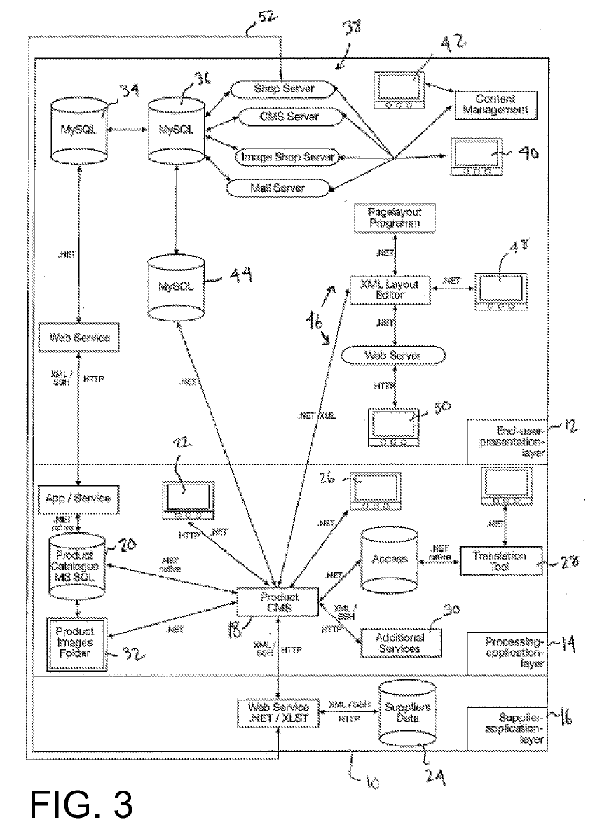

FIG. 3 depicts a system 10 for implementing the features of the present invention. System 10 provides a mechanism through which brand companies (e.g., NIKE, TITLIST, etc.) can present and sell products to end-users in a digital mall environment. System 10 operates on three levels, the end-user presentation layer 12, the processing application layer 14 and the supplier-application layer 16. The end-user presentation layer 12 is the layer at which shoppers and brand companies access the system 10. It is at this layer 12 that shoppers can view purchase products via a shop server. It is also at this layer 12 that brand companies can manage content and perform other such activities.

The processing application layer 14 includes a product content management system (CMS) 18 that is central to the operation of system 10. CMS 18 provides a conduit through which product information can flow from a supplier (i.e., brand company) into a product catalog database 20. CMS 18 may utilize a centralized data structure for representing offerings from any of the plurality of companies. CMS 18 includes an interface 22 that allows the brand company to load product data from the brand company's database 24 at the supplier-application layer 16 to the product catalog database 20. CMS 18 also allows the brand company to add product specific attributes such as descriptions and marketing texts and/or images via interface 22. Moreover, CMS 18 allows the brand company to re-categorize products and define workflows via interface 22.

The processing-application layer 14 also includes an administrative interface 26 that allows the system administrator (i.e., the manager of system 10) access to CMS 18, a translation tool 28 for translating product information between different spoken languages, additional services 30, and product image folders 32 that are associated with the product catalog database 20.

Once data is loaded into the product catalog database 20, it can be uploaded to a staging SQL database 34 in the end-user presentation layer 12. From there, the data is mirrored into a production SQL database 36 for security and performance purposes. A set of servers 38 are provided, including: a shop server that is utilized by consumers via a network interface (e.g., browser) 40; a CMS server that can be accessed by the brand companies to manage content via a content management interface 42, an image shop server for providing high resolution images, and a mail server for providing electronic newsletters and CRM to consumers. The high resolution images may be stored in an images database 44.

Also at the end user presentation layer 12 is an automated catalog production system 46 that allows brand companies to generate paper and/or electronic catalogs for dissemination. Automated catalog production system 46 includes a page layout program, an XML layout editor, and a web server. Brand companies can access automated catalog production system 46 via an editorial interface 50. An administrative interface 48 is also provided.

A feature of this embodiment is that as orders 52 are received from consumers via the shop server at the digital mall, the orders 52 can be routed directly back to the brand company's Enterprise Data Processing system (within the ERP), thus bypassing the processing application layer 14. Thus, order information 52 can be collected and managed in near real-time, as opposed to a batch process. Accordingly, brand companies get the benefits of a “third party” system for managing and presenting product information on the Web, but maintain control over order data.

Supplier application layer 16 includes a system such as Web services that allows data to directly interface with the suppliers data 24 in brand companies ERP system. This data include both information flowing back and forth through CMS 18 in the processing application layer 14 and order information from the end-user presentation layer 12. The supplier application layer 16 also maintains a log of data transfers. Management of communications between the end user presentation layer 12 and the supplier application layer 16 comprises converting and formatting data transferred between the two layers. The supplier application layer 16 may provide services comprising .NET/XSLT web-services for company data import/export services and order information import/export services. Data may in general be transmitted between the layers using, e.g., XML, hypertext, and NET and HTTP.

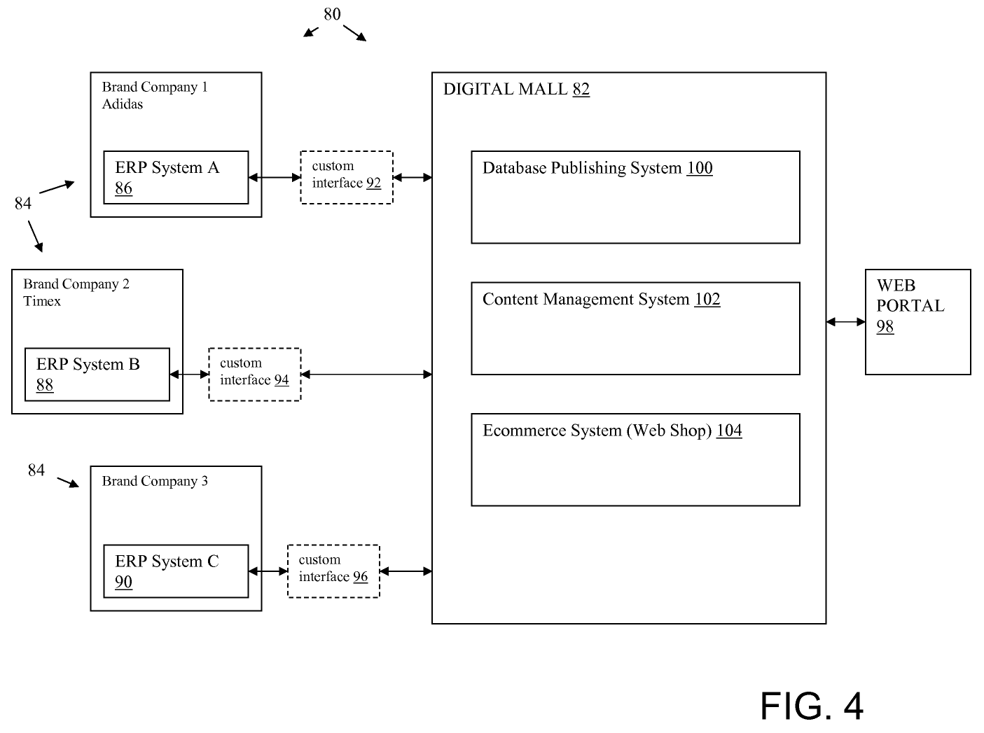

FIG. 4 depicts an overall architecture 80 of an implementation of the present invention. Architecture 80 includes a digital mall having the features described above in FIG. 3, a plurality of brand companies 84 that are linked to the digital mall 82, and a web portal 98 for providing end-user (i.e., shoppers and brand companies) access to the digital mall.

As can be seen, each brand company has its own proprietary ERP system 86, 88, 90. Accordingly, custom interfaces 92, 94 and 96 are provided that allow each brand company to interface directly with the digital mall 82.

In effect, digital mall 82 presents the brand companies 84 with various systems 100, 102, 104 that allows the brand companies to seamlessly market and sell their products in a real-time environment controlled by the brand companies. These systems includes a database publishing system 100 that provides a platform through which each company can publish some or all of its product content. Also included is a content management system 102 that manages the over all content from each of the different brand companies 84 and allows individual brand companies 84 to manage their individual content. Additionally, an ecommerce system 104 is provided that allows end-users the ability to browse and purchase products via web portal 98. As noted above, transactional data for purchases is routed directly back to the brand companies 84, thus eliminating batch processing delays and complications.

In general, the systems described above may be implemented using any type of types of computer system. Such computer systems could be implemented as part of a client and/or a server and generally include a processor, input/output (I/O), memory, and bus. The processor may comprise a single processing unit, or be distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, memory may reside at a single physical location, comprising one or more types of data storage, or be distributed across a plurality of physical systems in various forms.

I/O may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Although not shown, additional components, such as cache memory, communication systems, system software, etc., may be incorporated into the computer systems.

Access to system 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system comprising a CMS 18 and servers 38 could be created, maintained and/or deployed by a service provider that offers the functions described herein for end-users. That is, a service provider could offer to provide a digital mall interface as described above.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part or all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A system for providing automated processing of sales relevant product data for a plurality of companies via a common network node, comprising:
a supplier application layer that provides an interface with an ERP system associated with each of the plurality of companies, wherein the supplier application layer provides a conduit through which product content of each company can be accessed;
a processing application layer that includes a content management system for storing and managing product content for each of the plurality of companies, wherein the content management system allows each company to selectively load product content from their respective ERP system; and
an end user presentation layer that includes an interface for displaying product content from each of the plurality of companies, and for allowing end users to purchase products from each of the plurality of companies in which transaction data is routed directly back to the ERP system of a selling company via the supplier application layer.

2. The system of claim 1, wherein the supplier application layer provides services comprising .NET/XSLT web-services.

3. The system of claim 1, wherein the supplier application layer provides company data import/export services and order information import/export services.

4. The system of claim 1, wherein the supplier application layer maintains a log of data transfers.

5. The system of claim 1, wherein the processing application layer maintains a product catalog and product images folders, and utilizes a centralized data structure for representing offerings from any of the plurality of companies.

6. The system of claim 1, wherein the processing application layer includes product content translation services for translating content into different languages.

7. The system of claim 1, wherein each of the plurality of companies are provided with access to their own product offerings via the content management system.

8. The system of claim 1, wherein data transmitted between the layers are represented using XML, hypertext, and NET, and are transmitted using HTTP.

9. The system of claim 1, wherein the end user presentation layer provides content management services and email services.

10. The system of claim 1, wherein products are organized by brand for presentation to end users.

11. The system of claim 1, wherein the end-user-presentation-layer comprises a centralized data structure for representing offerings from any of the plurality of companies.

12. The system of claim 1, further comprising a catalog production system that allows each company to generate a catalog layout based on each company's product content via the content management system.

13. A program product stored on a computer readable medium for providing a digital mall over a computer network, comprising:
program code configured for providing a company interface with an ERP system associated with each of a plurality of companies, wherein the company interface provides a conduit through which product content of each company can be accessed;
program code for storing and managing product content for each of the plurality of companies, wherein program code for storing and managing product content allows each company to selectively load product content from their respective ERP system; and
program code for providing a user interface for displaying product content from each of the plurality of companies, and for allowing end users to purchase products from each of the plurality of companies wherein transaction data is routed directly back to the ERP system of a selling company via the company interface.

14. The program product of claim 13, wherein the company interface comprises .NET/XSLT web-services.

15. The program product of claim 13, wherein the program code for storing and managing product content maintains a product catalog and product images folders, and interfaces with a centralized data structure for representing offerings from any of the plurality of companies.

16. The program product of claim 13, wherein the program code for storing and managing product content includes program code for translating content into different languages.

17. The program product of claim 13, wherein each of the plurality of companies are provided with access to their own product offerings.

18. The program product of claim 13, wherein products are organized by brand for presentation to end users.

19. The program product of claim 13, further comprising program code that allows each company to generate a catalog layout based on product content of the company.

20. A method for providing a digital mall environment over a computer network, comprising:
providing a direct conduit through which product content of each of a plurality of companies can be accessed;
storing and managing product content for each of the plurality of companies obtained via the direct conduit in a centralized repository;
providing an interface for allowing each company to manage product content within the centralized repository;
providing a user interface via the computer network for displaying product content from each of the plurality of companies;
obtaining an order from an end user over the user interface; and
routing transaction data associated with the order directly back to a selling company via the direct conduit.

21. The method of claim 20, wherein the storing and managing of product content is maintained in a product catalog and product images folders.

22. The method of claim 20, further comprising translating product content into different languages.

23. The method of claim 20, wherein each of the plurality of companies are provided with access to their own product offerings via a network interface.

24. The method of claim 20, wherein product offerings are organized by brand for presentation to end users.

25. The method of claim 20, further comprising generating a catalog layout based on product content of the company.
